(19) United States
(12) Patent Application Publication
(10) Pub. No.: US 2023/0323097 A1
(43) Pub. Date: Oct. 12, 2023

(54) TIRE RUBBER COMPOSITION FOR HEAVY LOAD VEHICLE

(71) Applicant: The Goodyear Tire & Rubber Company, Akron, OH (US)

(72) Inventors: Daniel López Gaxiola, Akron, OH (US); Sean Michael Dillon, Wadsworth, OH (US)

(21) Appl. No.: 18/168,080

(22) Filed: Feb. 13, 2023

Related U.S. Application Data
(60) Provisional application No. 63/362,666, filed on Apr. 8, 2022.

(51) Int. Cl. C08L 9/00; B60C 1/00

(52) U.S. Cl. CPC C08L 9/00; B60C 1/0016; C08L 2205/025; C08L 2205/03

(57) ABSTRACT

A rubber composition for a heavy load tire comprises, based on 100 parts by weight of elastomer (phr), at least three diene elastomers each being a different rubber material. The elastomers include polybutadienes and a synthetic polyisoprene. The polybutadienes comprise a majority portion of a first polybutadiene synthesized with a lanthanide series catalyst, and a minority portion of second polybutadiene synthesized with a Nickel-based catalyst. The first and second polybutadienes are characterized by Mooney viscosities that are within ±5 MU of each other, while the synthetic polyisoprene is characterized by a Mooney viscosity higher than the polybutadienes. The at least three elastomers are each characterized by a high cis content of greater than 80 percent.

### FIELD OF THE INVENTION

The present disclosure relates to a rubber formulation for a heavy-load tire component and is described with particular reference thereto. However, it is to be appreciated that the present exemplary embodiments are amenable for incorporation in other rubber products and for like applications.

### BACKGROUND OF THE INVENTION

Tire abrasion is the unavoidable loss of rubber material during sliding contact with the road. Therefore, a repeated stop-and-go operation is expected to abrade the tires of certain heavy load (e.g., public transport and waste haul) vehicles. This can also lead to tread damage—in the form of separations—that prematurely destroy the tires.

For heavy load vehicles, the selection of materials for incorporation into the tire is material- and combination-specific. Various rubber compositions have been proposed in which a high natural rubber content is used for heavy load tires. Other compositions employ high butadiene content to improve abrasion resistance. Efforts to move away from these rubber polymers have led to processing challenges, such as hot tearing in the uncured state.

Here, a rubber composition is desired for heavy load tires. Such composition desirably displays improved green tack, strong adhesion, and high abrasion resistance in the cured state, but also displays no difficulty with processing—i.e., improves processability—in the uncured state. A new polymer blend is introduced from which a balance between performance and processability is observed.

### SUMMARY OF THE INVENTION

One embodiment of the disclosure is directed to a rubber composition for a heavy load tire. The heavy load tire rubber composition comprises, based on 100 parts by weight of elastomer (phr), at least three diene elastomers each being a different rubber material. The elastomers include polybutadienes and a synthetic polyisoprene. The polybutadienes comprise a majority portion of a first polybutadiene synthesized with a lanthanide series catalyst, and a minority portion of second polybutadiene synthesized with a Nickel-based catalyst. The first and second polybutadienes are characterized by Mooney viscosities that are within ±5 MU of each other, while the synthetic polyisoprene is characterized by a Mooney viscosity higher than the polybutadienes. The elastomers are each characterized by a high cis content of greater than 80 percent.

Another embodiment of the disclosure is also directed to a to a rubber composition for a heavy load tire. The heavy load tire rubber composition comprises, based on 100 parts by weight of elastomer (phr), about 10 phr to about 30 phr of a synthetic polyisoprene having a high cis content; and about 70 phr to about 90 phr two low Tg polybutadienes each having a high cis content. The primary polybutadiene is synthesized with a lanthanide series catalyst and the secondary/lesser polybutadiene is synthesized with catalyst of a different series. The heavy load tire rubber composition further comprises greater than 3 phr vegetable triglyceride rubber processing oil.

In the contemplated embodiment, the heavy load tire rubber composition is incorporated into a tread or ground-contacting tire component of a heavy load or heavy-duty vehicle.

### DETAILED DESCRIPTION OF THE INVENTION

As used herein, except where context requires otherwise, the term “comprise” and variations of the term, such as “comprising”, “comprises” and “comprised”, are not intended to exclude further additives, components, integers, or steps.

As used herein, the terms “rubbery polymer”, “polymer”, “rubber” and “elastomer” may be used interchangeably, unless otherwise prescribed. The terms “rubber composition,” “compounded rubber” and “rubber compound” are used interchangeably to refer to rubber which has been blended or mixed with various ingredients and materials and such terms are well known to those having skill in the rubber mixing or rubber compounding art.

The present disclosure is directed to a rubber composition for a heavy load tire. The heavy load tire rubber composition comprises, based on 100 parts by weight of elastomer (phr), at least three diene elastomers each being a different rubber material. The elastomers include (a) a first polybutadiene synthesized with a lanthanide series catalyst; (b) a second polybutadiene synthesized with a Nickel-based catalyst; and (c) a synthetic polyisoprene. The first polybutadiene is characterized by a glass transition temperature (Tg) below −100° C. The second polybutadiene is similarly characterized by a Tg within 5° difference of the first polybutadiene Tg. All three of the elastomers are characterized by a high cis content of greater than 80 percent.

### Rubber Elastomers

A critical aspect of the disclosed rubber compound is a tripolymer blend of conjugated diene-based elastomers. Representative conjugated diene-based elastomers are, for example, comprised of at least one of cis 1,4-polyisoprene (preferably synthetic) and cis 1,4-polybutadiene.

In practice, each elastomer is a different rubber polymer. Various rubber polymers may be used for the rubber composition such as, for example, polymers and copolymers of at least one of isoprene and 1,3-butadiene copolymerized with at least one of isoprene and 1,3-butadiene, and mixtures thereof. In one embodiment, the tripolymer blend is formed from all synthetic polymers.

Representative synthetic polymers are the homopolymerization products of butadiene and its homologues and derivatives, for example, methylbutadiene, dimethylbutadiene and pentadiene as well as copolymers such as those formed from butadiene or its homologues or derivatives with other unsaturated monomers. Among the latter are acetylenes, for example, vinyl acetylene; olefins, for example, isobutylene, which copolymerizes with isoprene to form butyl rubber; vinyl compounds, for example, acrylic acid, acrylonitrile, which polymerize with butadiene to form NBR, methacrylic acid and styrene, the latter compound polymerizing with butadiene to form SBR, as well as vinyl esters and various unsaturated aldehydes, ketones and ethers, e.g., acrolein, methyl isopropenyl ketone and vinylethyl ether.

Specific examples of synthetic rubbers include neoprene (polychloroprene), polybutadiene (including cis-1,4-polybutadiene), polyisoprene (including cis-1,4polyisoprene), butyl rubber, halobutyl rubber such as chlorobutyl rubber or bromobutyl rubber, styrene/isoprene/butadiene rubber, copolymers of 1,3-butadiene or isoprene with monomers such as styrene, acrylonitrile and methyl methacrylate, as well as ethylene/propylene terpolymers, also known as ethylene/propylene/diene monomer (EPDM), and in particular, ethyl ene/propyl ene/dicyclopentadiene terpolymers. Additional examples of rubbers which may be used include alkoxy-silyl end functionalized solution polymerized polymers (SBR, PBR, IBR and SIBR), silicon-coupled and tin-coupled star-branched polymers.

In practice, the preferred rubber or elastomers are polyisoprene and polybutadiene. Cis 1,4-polyisoprene and cis 1,4-polyisoprene natural rubber are well known to those having skill in the rubber art. In a preferred embodiment, the heavy load tire rubber composition contains synthetic polyisoprene and excludes natural rubber. The synthetic polyisoprene is desirable because it has a higher tack than natural rubber. It is observed that replacing natural rubber, used in conventional heavy load rubber compounds, with synthetic polyisoprene allows for improved resistance of the compound to hot tearing in its uncured state. This helps reduce the occurrence of tearing of the compound slab during manufacturing, and it also prevents downtime during cooling and laydown operations.

In the contemplated embodiment, the cis-1,4 polyisoprene is characterized by a high cis content of greater than 80% and, more preferably, greater than about 90%, as measured by QA 5114-01 (IR). In the contemplated embodiment, the rubber composition comprises from about 1 to about 49 phr and, more preferably, from about 5 to about 40 phr, and most preferably from about 10 to about 30 phr of synthetic polyisoprene.

An example polyisoprene that may be used in the disclosed rubber composition is, without limitation, the synthetic polyisoprene available from The Goodyear Tire & Rubber Corporation under the NATSYN trademark with designation 2200.

Generally, the disclosed rubber composition comprises the polyisoprene in a minority amount relative to total content of elastomer. The majority elastomer comprises a different synthetic polymer.

In practice, the rubber composition can comprise at least one and, more preferably, at least two high cis polybutadiene rubber(s) each, preferably, having a cis 1,4 content of at least about 80%, and more preferably more than about 90%, and most preferably more than about 95%, as measured by QA 5114-01 (IR). This is considered herein to contain branches of pendant polybutadiene groups along its molecular chain. In an embodiment, one or both of the two polybutadienes may be branched.

In practice, it is envisioned that at least one of the cis 1,4-polybutadiene elastomers may be prepared, for example, by polymerization of 1,3-polybutadiene monomer in an organic solvent solution in the presence of a lanthanide-based polymerization catalyst. Suitable catalyst may include lanthanide catalysts based on cerium, praseodymium, neodymium, or gadolinium. In one embodiment, the lanthanide-based polymerization catalyst is neodymium catalyst system.

In practice, it is envisioned that at least one of the cis 1,4-polybutadiene elastomers may be prepared, for example, by polymerization of 1,3-polybutadiene monomer in an organic solvent solution in the presence of a Nickel-based polymerization catalyst. Suitable catalyst may be based on a nickel compound, an organoaluminum compound, and a halogen compound.

In a contemplated embodiment, the rubber composition can comprise two cis 1,4-polybutadienes each prepared by a different catalyst. In one embodiment, the rubber composition can comprise a first cis 1,4-polybutadiene prepared by lanthanide-based catalyst and a second cis 1,4-polybutadiene prepared by a catalyst that is not lanthanide-based. In one embodiment, the rubber composition can comprise a first cis 1,4-polybutadiene prepared by lanthanide-based catalyst and a second cis 1,4-polybutadiene prepared by a Nickel-based catalyst. Such specialized polybutadienes would each have a medium or medium high Mooney viscosity (ML 1+4) at 100° C. in their unvulcanized states in a range of from about 30 to about 75 and, more specifically, from about 35 to about 45, as measured by ASTM D1646. In one embodiment, the polybutadiene rubbers are each characterized by a low glass transition temperature inflection point (Tg) below −80° C. and, more preferably, below −100° C., as measured by ASTM D3418. Preferably, the Tgs of the first and second polybutadienes are within 5° difference. In one example embodiment, the Tgs of the first and second polybutadienes can both be between −80° C. and −120° C. In certain embodiments, a polybutadiene blend both being characterized by a low Tg can be used to balance performance and processing.

Example polybutadienes that may be used in the disclosed rubber composition are, without limitation, the synthetic polybutadiene is available from The Goodyear Tire & Rubber Corporation under the BUD4001 and BUD24PRO tradenames or from LG Chem under the SABIC trademark with designation 4010.

In the contemplated embodiment, the rubber composition comprises from about 51 to about 99 phr and, more preferably, from about 60 to about 95 phr, and most preferably from about 70 to about 90 phr of polybutadienes. In one embodiment, the polybutadiene rubbers can be present at substantially equal levels, but the preferred embodiment contemplates a first and at least a second polybutadiene at different levels. In one embodiment, the rubber composition comprises from about 35 to about 90 phr and, more preferably, from about 40 to about 80 phr, and most preferably from about 50 to about 70 phr of a first polybutadiene, which is formed using the lanthanide-based catalyst. The first polybutadiene is present in a majority portion, which means that it is present at a level that is higher than each of the other rubber polymers in the blend. In a preferred embodiment, the first polybutadiene is present at a level that is greater than the combined total of other polymers in the blend. In one embodiment, the rubber composition comprises from about 1 to about 35 phr and, more preferably, from about 10 to about 30 phr of a second polybutadiene, which is formed using a catalyst that is different from the first polybutadiene. The second polybutadiene is present in a minority portion, which means that it is present at a level that is lower than first polybutadiene in the blend. In a preferred embodiment, the second polybutadiene is present at a level that is equal to or lower than the other elastomer (e.g., polyisoprene) in the blend.

It is discovered that incorporation of the second polybutadiene in the disclosed composition improves processability in such ways that further improve appearance and porosity as compared to the conventional compounds.

In certain embodiments, the first polybutadiene can be present relative to the second polybutadiene in about a 2:1 to about a 4:1 ratio; the first polybutadiene can be present relative to the polyisoprene in about a 2:1 to about a 4:1 ratio; and the second polybutadiene can be present relative to the polyisoprene in about a 2:1 to about a 1:2 ratio. In practice the first polybutadiene, second polybutadiene, and polyisoprene are present in about a 3:1:1 ratio+/−5 phr.

### Oil

In one embodiment, the heavy load rubber composition includes at least one oil. In one embodiment, the rubber composition may comprise up to about 20 phr of rubber processing oil. In another embodiment, the rubber composition oil may comprise no less than about 2 phr of rubber processing oil. In practice, the rubber processing oil may be present at from about 2 to about 10 phr and, more preferably, from about 2.5 to about 5 phr of rubber processing oil. Processing oil may be included in the rubber composition as extending oil typically used to extend elastomers. Processing oil may also be included in the rubber composition by addition of the oil directly during rubber compounding. The processing oil used in the rubber composition may include both extending oil present in the elastomers and process oil added during compounding. Suitable process oils include various oils as are known in the art, including aromatic, paraffinic, naphthenic, vegetable triglyceride oils, and low PCA oils, such as IVIES, TDAE, SRAE and heavy naphthenic oils. Suitable low PCA oils include those having a polycyclic aromatic content of less than 3 percent by weight as determined by the IP346 method. Procedures for the IP346 method may be found in Standard Methods for Analysis & Testing of Petroleum and Related Products and British Standard 2000 Parts, 2003, 62nd edition, published by the Institute of Petroleum, United Kingdom.

A suitable vegetable triglyceride oil is comprised of a combination of saturated and unsaturated esters where the unsaturated esters are comprised of a combination of at least one of oleic acid ester, linoleate acid ester and linoleate acid ester. The saturated esters may be comprised of, for example, and not intended to be limiting, at least one of stearic acid ester and palmitic acid ester.

In one embodiment, the vegetable triglyceride oil is comprised of at least one of soybean oil, sunflower oil, rapeseed oil, and canola oil. In practice, the rubber composition includes at least one of soybean oil and sunflower oil. In a preferred embodiment, the rubber composition excludes a petroleum-derived oil.

### Resin(s):

The rubber composition may optionally include at least about 1 phr, and more preferably at least 3 phr, and most preferably at least 4 phr of resin. The disclosed heavy load tire rubber composition contains a higher level of resin compared to the conventional heavy load tire compound.

A suitable measurement of Tg for resins is DSC according to ASTM D6604 or equivalent. Resin softening point is determined by ASTM E28, which might sometimes be referred to as a ring and ball softening point. In one embodiment, the rubber composition may optionally include a resin or combination of resins each having a softening point above 80° C.

The resin may be selected from the group consisting of any hydrocarbon chemistry type resin (AMS, coumarone-indene, C5, C9, C5/C9, DCPD, DCPD/C9, others) & any modification thereof (phenol, C9, hydrogenation, recycled monomers, others) and any renewable biobased chemistry type resin (like any polyterpene, gum rosin, tall oil rosin, etc) & modification (phenol, C9, hydrogenation, DCPD, esters, others) and mixture thereof.

In one embodiment, the resin may be a coumarone-indene resin containing coumarone and indene as the monomer components making up the resin skeleton (main chain). Monomer ingredients other than coumarone and indene which may be incorporated into the skeleton are, for example, methyl coumarone, styrene, alphamethylstyrene, methylindene, vinyltoluene, dicyclopentadiene, cycopentadiene, and diolefins such as isoprene and piperlyene.

Suitable petroleum resins include both aromatic and nonaromatic and aliphatic types. Several types of petroleum resins are available. Some resins have a low degree of unsaturation and high aromatic content, whereas some are highly unsaturated and yet some contain no aromatic structure at all. Differences in the resins are largely due to the olefins in the feedstock from which the resins are derived. Conventional derivatives in such resins include any C5 species (olefins and diolefins containing an average of five carbon atoms) such as cyclopentadiene, dicyclopentadiene, diolefins such as isoprene and piperylene, and any C9 species (olefins and diolefins containing an average of 9 carbon atoms) such as vinyltoluene, alphamethylstyrene and indene. Such resins are made by any mixture formed from C5 and C9 species mentioned above.

The styrene/alphamethylstyrene resin is considered herein to be a relatively short chain copolymer of styrene and alphamethylstyrene. The styrene/alphamethylstyrene resin may have, for example, a styrene content in a range of from about 10 to about 90 percent. In one aspect, such a resin can be suitably prepared, for example, by cationic copolymerization of styrene and alphamethylstyrene in a hydrocarbon solvent. Thus, the contemplated styrene/alphamethylstyrene resin can be characterized, for example, by its chemical structure, namely, its styrene and alphamethylstyrene contents and by its glass transition temperature, molecular weight and molecular weight distribution. Suitable alphamethylstyrene resin is available commercially as SYLVATRAXX 4401 from multiple suppliers.

Terpene-phenol resins may be used. Terpene-phenol resins may be derived by copolymerization of phenolic monomers with terpenes such as limonenes, pinenes and delta-3-carene.

Additional types of resins are those derived from rosin and derivatives. Representative thereof are, for example, gum rosin, wood rosin and tall oil rosin. Gum rosin, wood rosin and tall oil rosin have similar compositions, although the number of components of the rosins may vary. Such resins may be dimerized, polymerized or disproportionated. Such resins may be in the form of esters of rosin acids and polyols such as pentaerythritol or glycol.

In one embodiment, said resin may be partially or fully hydrogenated.

In practice, at least two resins—preferably traction and tackifyng—are employed. The combination of an aliphatic hydrocarbon resin with an alpha-methyl (AMS) styrene resin (characterized by both aliphatic and aromatic content) were discovered to improve green tack in the disclosed composition. This improved green tack reduces the risk of tire separations that are caused by low uncured adhesion in conventional heavy-load compounds. Particularly, one embodiment contemplates a majority phr of the resin content being the AMS with a minority phr of the resin content being the aliphatic hydrocarbon.

### Curing Agent:

A critical aspect of the present disclosure is the cure package. Accelerators are used to control the time and/or temperature required for vulcanization and to improve the properties of the vulcanizate. Typically, the rubber compositions for conventional heavy load tires use primary and secondary accelerators. Combinations of these accelerators might be expected to produce a synergistic effect on the final properties of a conventional compound and are somewhat better than those produced by use of either accelerator alone. Example primary accelerators are amines, disulfides, thioureas, thiazoles, sulfenamides (e.g., N-cyclohexyl-2-benzothiazolesulphenamide (CBS), and N-Tertbutyl-2-Benzothiazolesulfenamide (TBBS)) and xanthates. Specific examples of secondary accelerators are a guanidine (e.g., diphenylguanidine (DPG)), dithiocarbamate or thiuram compound.

It is now discovered that the present compound maintains and/or improves curing in the absence of a secondary accelerator or combination of accelerators. Previously, and more particularly, a silica filler necessitates the use of a secondary or combination of accelerator(s), such as a guanidine, to make the compound cure faster. The present disclosed composition provides similar properties (e.g., curing rate) in the absence of the secondary accelerator. In one embodiment, the heavy load rubber composition excludes a secondary accelerator.

Embodiments are contemplated in which a single accelerator system may be used, i.e., primary accelerator. The primary accelerator(s) may be used in total amounts ranging from about 0.5 to about 6, preferably about 1 to about 4, phr. Preferably, the primary accelerator is a sulfenamide. One non-limiting example of a sulfenamide is N-Tertbutyl-2-Benzothiazolesulfenamide (TBBS).

In addition, delayed action accelerators may be used which are not affected by normal processing temperatures but produce a satisfactory cure at ordinary vulcanization temperatures. Vulcanization retarders might also be used. A nonlimiting example of a retarder can be N-cyclohexylthiophthalimide (CTP).

### Reinforcement Network

The present compound also comprises a filler system or reinforcement network. The filler system comprises at least carbon black and silica in combination. In one embodiment, the majority filler is carbon black. In one embodiment, the minority filler portion belongs to silica. In the contemplated embodiment, the reinforcement network comprises a balance of carbon black to silica in about a 3:1 to about 4:1 ratio.

In one example, the carbon black is present in the rubber compound in an amount no less than about 20 phr. In another example, the carbon black is present in an amount of no more than 80 phr. In yet another example, the carbon black may be present in an amount of from about 30 phr to about 60 phr and, more preferably, from about 40 phr to about 50 phr.

In one example, the silica is present in the rubber compound in an amount no less than about 5 phr. In another example, the silica is present in an amount of no more than 30 phr. In yet another example, the silica may be present in an amount of from about 10 phr to about 20 phr and, more preferably, from about 10 phr to about 15 phr.

Representative examples of carbon blacks include N110, N121, N134, N220, N231, N234, N242, N293, N299, S315, N326, N330, M332, N339, N343, N347, N351, N358, N375, N539, N550, N582, N630, N642, N650, N683, N754, N762, N765, N774, N787, N907, N908, N990 and N991. These carbon blacks have iodine absorptions ranging from 9 to 145 g/kg and DBP number ranging from 34 to 150 cm³/100 g.

The silica filler may be any suitable silica or a combination of any such silica. Commonly used siliceous pigments that are used in rubber compounding applications include pyrogenic and precipitated siliceous pigments (silica), as well as precipitated high surface area (“HSA”) silica and highly dispersive silica (“HDS”).

The conventional siliceous pigments preferably employed in this invention are precipitated silicas such as, for example, those obtained by the acidification of a soluble silicate, e.g., sodium silicate.

The precipitated silicas can be characterized, for example, by having a BET surface area, as measured using nitrogen gas, preferably in the range of about 40 to about 600, and more usually in a range of about 50 to about 300 square meters per gram. The BET method of measuring surface area is described in the Journal of the American Chemical Society, Volume 60, page 304 (1930). The conventional silica may also be typically characterized by having a dibutylphthalate (DBP) absorption value in a range of about 100 to about 400, and more usually about 150 to about 300. The conventional silica might be expected to have an average ultimate particle size, for example, in the range of 0.01 to 0.05 micron as determined by the electron microscope, although the silica particles may be even smaller, or possibly larger, in size.

When precipitated silica is a pre-hydrophobated precipitated silica, additional precipitated silica (non-pre-hydrophobated silica) and/or a coupling agent may optionally be added to the rubber composition.

Other fillers that may be used in the rubber composition include, but are not limited to, particulate fillers such as ultra-high molecular weight polyethylene (UHMWPE), particulate polymer gels, and plasticized starch composite filler.

In one embodiment, the rubber composition may also include a (e.g., silane) coupling, such as bis(ω-trialkoxyalkylsilyl) polysulfide, w-mercaptoalkyl-trialkoxysilane, or combination thereof. In one example, the bis-(ω-trialkoxysilylalkyl) polysulfide has an average of from about 2 to about 4 connecting sulfur atoms in its polysulfidic bridge. In another example, the bis-(ω-trialkoxysilylalkyl) polysulfide has an average of from about 2 to about 2.6 connecting sulfur atoms in its polysuflidic bridge. In yet another example, the bis-(ω-trialkoxysilylalkyl)polysulfide has an average of from about 3.3 to about 3.8 connecting sulfur atoms in its polysulfidic bridge. The alkyl group of the silylalkyl moiety of the bis-(ω-trialkoxysilylalkyl)polysulfide may be a saturated C₂-C₆ alkyl group, e.g., a propyl group. In addition, at least one of the alkyl groups of the trialkoxy moiety of the bis-(ω-trialkoxysilylalkyl)polysulfide can be an ethyl group and the remaining alkyl groups of the trialkoxy moiety can be independently saturated C₂-C₁₈ alkyls. In another example, at least two of the alkyl groups of the trialkoxy moiety of the bis-(ω-trialkoxysilylalkyl) polysulfide are ethyl groups and the remaining alkyl group of the trialkoxy moiety is independently a saturated C₃-C₁₈ alkyl. In one example, the bis-(ω-trialkoxysilylalkyl) polysulfide coupling agent is bis-3-(triethoxysilylpropyl) tetrasulfide (“TESPD”). In another example, the bis-(ω-trialkoxysilylalkyl) Polysulfide coupling agent is bis-3-(triethoxysilylpropyl) tetrasulfide (“TESPT”). The ω-mercaptoalkyltrialkoxysilane may have its mercapto moiety blocked from pre-reacting with hydroxyl groups (e.g., silanol groups) contained on the precipitated silica aggregates prior to unblocking the blocked mercapto moiety at an elevated temperature. In one example, the blocked w-mercaptoalkyl-trialkoxysilane is NXT or NXT-LoV available from GE Silicones of Tarrytown, N.Y.

The silane coupling agent is present in the rubber compound in an amount no less than 10% by weight of silica. In another example, the silane coupling agent is present in an amount no more than about 20% by weight of silica.

The silane coupling agent may be present in an amount between from about 0 to about 10 phr and, more specifically, from about 0.5 to about 5 phr. The silane coupling agent may be present in the rubber compound in an amount no greater than 5 phr and, more specifically, 4 phr in some embodiments. In another example, the silane coupling agent may be present in an amount no less than about 2 phr and, in certain embodiments, 3 phr.

### Sulfur Curative

It may be preferred to have the rubber composition for use in the tire component to additionally contain a conventional sulfur containing organosilicon compound. Examples of suitable sulfur containing organosilicon compounds are of the formula:

Z-Alk-Sₙ-Alk-Z I

in which Z is selected from the group consisting of

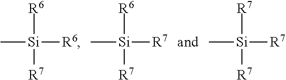

where R⁶ is an alkyl group of 1 to 4 carbon atoms, cyclohexyl or phenyl; R⁷ is alkoxy of 1 to 8 carbon atoms, or cycloalkoxy of 5 to 8 carbon atoms; Alk is a divalent hydrocarbon of 1 to 18 carbon atoms and n is an integer of 2 to 8.

Specific examples of sulfur containing organosilicon compounds which may be used in accordance with the present invention include: 3,3′-bis(trimethoxysilylpropyl) disulfide, 3,3′-bis (triethoxysilylpropyl) disulfide, 3,3′-bis(triethoxysilylpropyl) tetrasulfide, 3,3′-bis(triethoxysilylpropyl) octasulfide, 3,3′-bis(trimethoxysilylpropyl) tetrasulfide, 2,2′-bis(tri ethoxy silyl ethyl) tetrasulfide, 3,3′-bis(trimethoxysilylpropyl) trisulfide, 3,3′-bis(triethoxysilylpropyl) trisulfide, 3,3′-bis(tributoxysilylpropyl) disulfide, 3,3′-bis(trimethoxysilylpropyl) hexasulfide, 3,3′-bis(trimethoxysilylpropyl) octasulfide, 3,3′-bis(trioctoxysilylpropyl) tetrasulfide, 3,3′-bis(trihexoxysilylpropyl) disulfide, 3,3′-bis(tri-2″-ethylhexoxysilylpropyl) trisulfide, 3,3′-bis(triisooctoxysilylpropyl) tetrasulfide, 3,3′-bis(tri-t-butoxysilylpropyl) disulfide, 2,2′-bis(methoxy diethoxy silyl ethyl) tetrasulfide, 2,2′-bis(tripropoxysilylethyl) pentasulfide, 3,3′-bis(tricyclonexoxysilylpropyl) tetrasulfide, 3,3′-bis(tricyclopentoxysilylpropyl) trisulfide, 2,2′-bis(tri-2″-methylcyclohexoxysilylethyl) tetrasulfide, bis(trimethoxysilylmethyl) tetrasulfide, 3-methoxy ethoxy propoxysilyl 3′-diethoxybutoxy-silylpropyltetrasulfide, 2,2′-bis(dimethyl methoxysilylethyl) disulfide, 2,2′-bis(dimethyl sec.butoxysilylethyl) trisulfide, 3,3′-bis(methyl butyl ethoxy silyl propyl) tetrasulfide, 3,3′-bis(di t-butylmethoxysilylpropyl) tetrasulfide, 2,2′-bis(phenyl methyl methoxysilylethyl) trisulfide, 3,3′-bis(diphenyl isopropoxysilylpropyl) tetrasulfide, 3,3′-bis(diphenyl cyclohexoxysilylpropyl) disulfide, 3,3′-bis(dimethyl ethylmercaptosilylpropyl) tetrasulfide, 2,2′-bis(methyl dim ethoxy silyl ethyl) trisulfide, 2,2′-bis(methyl ethoxyprop oxy silyl ethyl) tetrasulfide, 3,3′-bis(diethyl methoxysilylpropyl) tetrasulfide, 3,3′-bis(ethyl di-sec. butoxysilylpropyl) disulfide, 3,3′-bis(propyl diethoxysilylpropyl) disulfide, 3,3′-bis(butyl dimethoxysilylpropyl) trisulfide, 3,3′-bis(phenyl dimethoxysilylpropyl) tetrasulfide, 3-phenyl ethoxybutoxysilyl 3′-trimethoxysilylpropyl tetrasulfide, 4,4′-bis(trimethoxysilylbutyl) tetrasulfide, 6,6′-bis(triethoxysilylhexyl) tetrasulfide, 12,12′-bis(triisopropoxysilyl dodecyl) disulfide, 18,18′-bis(trimethoxysilyloctadecyl) tetrasulfide, 18,18′-bis(tripropoxysilyloctadecenyl) tetrasulfide, 4,4′-bis(trimethoxysilyl-buten-2-yl) tetrasulfide, 4,4′-bis(trimethoxysilylcyclohexylene) tetrasulfide, 5,5′-bis(dimethoxymethylsilylpentyl) trisulfide, 3,3′-bis(trimethoxysilyl-2-methylpropyl) tetrasulfide, 3,3′-bis(dimethoxyphenyl silyl-2-methyl propyl) disulfide.

The preferred sulfur containing organosilicon compounds are the 3,3′-bis(trimethoxy or triethoxy silylpropyl) sulfides. The most preferred compounds are 3,3′-bis(triethoxysilylpropyl) disulfide and 3,3′-bis(triethoxysilylpropyl) tetrasulfide. Therefore, as to formula I, preferably Z is

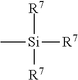

where R⁷ is an alkoxy of 2 to 4 carbon atoms, with 2 carbon atoms being particularly preferred; alk is a divalent hydrocarbon of 2 to 4 carbon atoms with 3 carbon atoms being particularly preferred; and n is an integer of from 2 to 5 with 2 and 4 being particularly preferred. In another embodiment, suitable sulfur containing organosilicon compounds include compounds disclosed in U.S. Pat. No. 6,608,125. In one embodiment, the sulfur containing organosilicon compounds includes 3-(octanoylthio)-1-propyltriethoxysilane, CH₃(CH₂)₆C(═O)—S—CH₂CH₂CH₂Si(OCH₂CH₃)₃, which is available commercially as NXT™ from Momentive Performance Materials.

In another embodiment, suitable sulfur containing organosilicon compounds include the reaction product of hydrocarbon based diol (e.g., 2-methyl-1,3-propanediol) with S-[3-(triethoxysilyl)propyl] thiooctanoate. In one embodiment, the sulfur containing organosilicon compound is Si-363 from Degussa.

The amount of the sulfur containing organosilicon compound of formula I in a rubber composition will vary depending on the level of other additives that are used. The amount of the compound of formula I will range from 0.5 to 20 phr. Preferably, the amount will range from 1 to 10 phr.

### Additive

It is readily understood by those having skill in the art that the rubber composition would be compounded by methods generally known in the rubber compounding art, such as mixing the various sulfur-vulcanizable constituent rubbers with various commonly used additive materials such as, for example, sulfur donors, curing aids, such as activators, accelerators and retarders and processing additives, fillers, pigments, fatty acid, zinc oxide, waxes, antioxidants and antiozonants and peptizing agents. As known to those skilled in the art, depending on the intended use of the sulfur vulcanizable and sulfur-vulcanized material (rubbers), the additives mentioned above are selected and commonly used in conventional amounts. Representative examples of sulfur donors include elemental sulfur (free sulfur), an amine disulfide, polymeric polysulfide and sulfur olefin adducts. Preferably, the sulfur-vulcanizing agent is elemental sulfur. The sulfur-vulcanizing agent may be used in an amount ranging from 0.5 to 8 phr, with a range of from 1 to 6 phr being preferred. Typical amounts of antioxidants comprise about 0.5 to about 5 phr. Representative antioxidants may be, for example, polymerized trimethyl dihydroquinoline, mixture of aryl-p-phenylene diamines, and others, such as, for example, those disclosed in The Vanderbilt Rubber Handbook (1978), pages 344 through 346. Typical amounts of antiozonants comprise about 1 to 5 phr. A non-limiting representative antiozonant can be, for example, N-(1,3 dimethyl butyl)-n′-phenyl-p-phenylenediamine. Typical amounts of fatty acids, if used, which can include stearic acid as an example, can comprise about 0.5 to about 5 phr. Typical amounts of waxes comprise about 1 to about 5 phr. Often microcrystalline waxes are used, but refined paraffin waxes or combinations of both can be used. Typical amounts of peptizers comprise about 0.1 to about 1 phr. Typical peptizers may be, for example, pentachlorothiophenol and dibenzamidodiphenyl disulfide.

The mixing of the rubber composition can be accomplished by methods known to those having skill in the rubber mixing art. For example, the ingredients are typically mixed in at least two stages, namely, at least one non-productive stage followed by a productive mix stage. The final curatives including sulfur-vulcanizing agents are typically mixed in the final stage which is conventionally called the “productive” mix stage in which the mixing typically occurs at a temperature, or ultimate temperature, lower than the mix temperature(s) of the preceding non-productive mix stage(s). The terms “non-productive” and “productive” mix stages are well known to those having skill in the rubber mixing art. The rubber composition may be subjected to a thermomechanical mixing step. The thermomechanical mixing step generally comprises a mechanical working in a mixer or extruder for a period of time suitable in order to produce a rubber temperature between 140° C. and 190° C. The appropriate duration of the thermomechanical working varies as a function of the operating conditions, and the volume and nature of the components. For example, the thermomechanical working may be from 1 to 20 minutes.

Vulcanization of a pneumatic tire of the present invention is generally carried out at conventional temperatures ranging from about 100° C. to 200° C. Preferably, the vulcanization is conducted at temperatures ranging from about 110° C. to 180° C. Any of the usual vulcanization processes may be used such as heating in a press or mold, heating with superheated steam or hot air. Such tires can be built, shaped, molded and cured by various methods which are known and will be readily apparent to those having skill in such art.

The disclosure contemplates a heavy load tire component formed from such method. The tire component can be ground contacting or non-ground contacting. The tire can be pneumatic or non-pneumatic. In one embodiment, the tire component can be a tread.

The tire of the present disclosure may be a race tire, passenger tire, aircraft tire, agricultural, earthmover, off-the-road, truck (commercial or passenger) tire, and the like. Preferably, the tire is for a heavy load or heavy-duty vehicle, such as a bus, garbage truck, and the like. The tire may also be a radial or bias, with a radial being preferred.

The rubber composition itself may also be useful as a tire sidewall or other tire components or in rubber tracks, conveyor belts or other industrial product applications. Particularly, improved abrasion resistance offers advantages in a wide variety of rubber products, such as windshield wiper blades, brake diaphragms, washers, seals, gaskets, hoses, conveyor belts, power transmission belts, shoe soles, shoe foxing and floor mats for buildings or automotive applications.

The following examples are presented for the purposes of illustrating and not limiting the present invention. All parts are parts by weight unless specifically identified otherwise.

### Example 1

In this example, the effects on the performance of rubber compounds are illustrated for compounds comprising a tri-polymer blend of polymers each containing a high cis content.

Rubber compounds were mixed in a multi-step mixing procedure following the recipes in Table 1. Standard amounts of additive materials and curing techniques were also used. The rubber compounds were then cured and tested for various properties including, inter alia, abrasion resistance and cured stiffness.

A control rubber compound (representing a conventional heavy load tire rubber compound) was prepared as Control Sample A using a tri-polymer blend of isoprene (natural rubber), a majority portion of Ni-catalyzed polybutadiene, and a minority portion of Nd-catalyzed polybutadiene.

For the Experimental Sample B, a rubber compound was prepared by replacing the natural rubber with equal parts synthetic polyisoprene; and by instead using a majority portion of Nd-catalyzed polybutadiene and a minority portion of Ni-catalyzed polybutadiene. Experimental Sample B also replaced the Nd-catalyzed polybutadiene with one having lower Mooney viscosity and added a resin.

The basic formulations are illustrated in the following Table 1, which is presented in parts per 100 parts by weight of elastomers (phr).

TABLE 1

| | Samples | |
|---|---|---|
| | Control | Experimental |
| | A | B |
| Natural Rubber | 20 | 0 |
| Synthetic Polyisoprene | 0 | 20 |
| Polybutadiene A¹ | 50 | 20 |
| Polybutadiene B² | 30 | 0 |
| Polybutadiene C³ | 0 | 60 |
| Processing Oil (Soybean) | 4.6 | 3.0 |
| Carbon Black | 48 | 49 |
| Silica | 10 | 15 |
| Silica Coupler | 2.5 | 1.8 |
| Traction Resin⁴ | 0 | 3.5 |
| Tackifying Resin⁵ | 0 | 1 |
| Primary Accelerator⁶ | 0.5 | 1.5 |
| Secondary Accelerator⁷ | 0.8 | 0 |
| Blend of fatty acid derivatives | 0.9 | 0 |
| Additive | 0 | 2 |
| Sulfur | 1.5 | 1.3 |

¹High cis 1,4-polybutadiene, Ni, branched with Tg −106° and Mooney Viscosity 40.00 obtained from the Goodyear Tire & Rubber Company
²High cis 1,4-polybutadiene, Nd with Tg −106° and Mooney Viscosity 55.00 obtained from the Goodyear Tire & Rubber Company
³High cis 1,4-polybutadiene, Nd with Tg −106° and Mooney Viscosity 40.00 obtained from the Goodyear Tire & Rubber Company
⁴Alspha-methylstyrene resin
⁵Straight chained petroleum hydrocarbon resin
⁶TBBS
⁷CBS

Various cured rubber properties of the Control sample A and the Experimental sample B are reported in the following Table 2 with the results from the Control being normalized to values of 100 and the results for the Experimental sample B being related to the normalized values.

TABLE 2

| | Samples | |
|---|---|---|
| | Control | Experimental |
| | A | B |
| | % | % |
| Material incorporation | | |
| Specific gravity | 100 | 101 |
| Processability | | |
| RPA500 G′ uncured at 0.83 Hz | 100 | 117 |
| Dynamic modulus | | |
| RPA500 G′ cured at 10% strain | 100 | 105 |
| RPA500 G′ cured at 50% strain | 100 | 107 |
| Heat generation | | |
| Zwick Rebound at 100° C. | 100 | 100 |
| RPA500 tan d at 10% strain | 100 | 102 |
| Elongation | | |
| Ring MTE - Elongation at break | 100 | 99 |
| Tear Resistance | | |
| Strebler SS avg. load/width (at 95° C.) | 100 | 109 |
| Aged Strebler SS avg. load/width (at 95° C) | 100 | 114 |
| Instron tear avg. force/width (at 95° C) | 100 | 113 |
| Chip/Flake Indicator | | |
| FDF factor | 100 | 107 |
| Crack-growth resistance | | |
| Aged DeMattia crack growth rate | 100 | 90 |
| Abrasion resistance | | |
| Grosch Abrasion rate (high severity) | 100 | 102 |
| Grosch Abrasion rate (ultra-high severity) | 100 | 103 |
| Wet traction | | |
| Zwick Rebound at 0° | 100 | 101 |

As can be seen in Table 2, the overall performance properties of the heavy load tire rubber compound B (utilizing an all-synthetic tri-polymer blend) compared favorably with the performance properties of the Control A.

Experimental Sample B displays improved adhesion over the Control A. This is shown by higher Strebler and Instron tear values.

The Experimental Sample B demonstrates improved stiffness over the Control A.

This is shown by higher dynamic modulus values across increasing strain percent. Additionally, Sample B demonstrates improved abradability values over Control A when measured across increasing severities using the Grosch abrasion test. Therefore, the results indicate that the disclosed compound improved abrasion resistance over the conventional compound A.

Indeed, Sample B displays at least a 3% improvement in abrasion resistance, and at least a 5% improvement in stiffness. Sample B also displays improved processability despite increased silica level in the absence of a combination of accelerators. It is believed, that for the same reason, Sample B provides an improved scorch-safety compared to the conventional Control A.

It is hereby concluded that the presently disclosed rubber compounds are useful for heavy load tire treads when such compounds comprise the disclosed all synthetic tripolymer blend with resin and reduced cure package.

One aspect of the disclosed composition is that it provides a balance between processability and performance by, advantageously, improving both without a demand for tradeoff.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A rubber composition for a heavy load tire comprising, based on 100 parts by weight of elastomer (phr):
at least three diene elastomers each being a different rubber material, the elastomers comprising:
(a) polybutadienes comprising:
(i) a majority portion of first polybutadiene synthesized with a lanthanide series catalyst, the first polybutadiene being characterized by a first Mooney viscosity;
(ii) a minority portion of second polybutadiene synthesized with a Nickel-based catalyst, the second polybutadiene characterized by a second Mooney viscosity within ±5 MU of the first Mooney viscosity;
(b) a synthetic polyisoprene;
wherein each of the at least three elastomers are characterized by a high cis content of greater than 80 percent.

2. The heavy load tire rubber composition of claim 1, wherein the first polybutadiene is catalyzed with neodymium (Nd) and the second polybutadiene is catalyzed with nickel (Ni).

3. The heavy load tire rubber composition of claim 1, wherein the at least three diene elastomers exclude natural rubber (NR).

4. The heavy load tire rubber composition of claim 1 further comprising silica and excluding a secondary accelerator.

5. The heavy load tire rubber composition of claim 1, further comprising silica and excluding a combination of accelerators.

6. The heavy load tire rubber composition of claim 1, further comprising silica and excluding N-cyclohexyl-2-benzothiazolesulphenamide (CBS).

7. The heavy load tire rubber composition of claim 1, excluding additional polymer elastomers.

8. The heavy load tire rubber composition of claim 1, comprising greater than 2 phr vegetable triglyceride oil.

9. The heavy load tire rubber composition of claim 1, comprising greater than 2 phr soybean oil.

10. The heavy load tire rubber composition of claim 1, excluding petroleum-derived rubber processing oil.

11. The heavy load tire rubber composition of claim 1, comprising greater than about 4 phr total of one or a combination of resin.

12. The heavy load tire rubber composition of claim 1, wherein the first and second polybutadienes each have a glass transition temperature (Tg) below −100° C.

13. The heavy load tire rubber composition of claim 12, wherein a difference in the Tg between the first and second polybutadienes is less than 5° C.

14. The heavy load tire rubber composition of claim 1, wherein the first polybutadiene is present in a majority content level relative to a total content level of all other elastomers in the rubber composition.

15. The heavy load tire rubber composition of claim 1, wherein the second polybutadiene and the polyisoprene are present in about a 1:1 ratio.

16. The heavy load tire rubber composition of claim 1, wherein the rubber composition is for incorporation in a tread or ground contacting component.

17. The heavy load tire rubber composition of claim 1, comprising:
about 10 phr to about 30 phr of the synthetic polyisoprene; and
about 70 phr to about 90 phr of a combined first and second polybutadienes.

18. The heavy load tire rubber composition of claim 17, comprising:
about 50 to about 70 phr of the first polybutadiene; and
about 10 to about 30 phr of the second polybutadiene.

19. A rubber composition for a heavy load tire comprising, based on 100 parts by weight of elastomer (phr):
about 10 phr to about 30 phr of a synthetic polyisoprene having a high cis content;
about 70 phr to about 90 phr two low Tg polybutadienes each having a high cis content;
the major polybutadiene being synthesized with a lanthanide series catalyst and the minor polybutadiene not being synthesized with a lanthanide series catalyst; and
greater than 3 phr vegetable triglyceride rubber processing oil.

20. The heavy load tire rubber composition of claim 19, wherein the two polybutadienes are characterized by similar Tg and Mooney viscosity.
